(19) United States
(12) Patent Application Publication
(10) Pub. No.: US 2016/0110083 A1
(43) Pub. Date: Apr. 21, 2016

(54) LIMITING VISIBILITY INTO USER SOCIAL MEDIA DATA BASED ON USER ATTRIBUTES

(71) Applicant: KBR IP Holdings, LLC, Provo, UT (US)

(72) Inventors: Nathaniel Brent Kranendonk, Springville, UT (US); Brett Leon Ross, Salt Lake City, UT (US)

(21) Appl. No.: 14/881,421

(22) Filed: Oct. 13, 2015

Related U.S. Application Data
(60) Provisional application No. 62/064,312, filed on Oct. 15, 2014.

(51) Int. Cl. G06F 3/0484; G06F 17/30

(52) U.S. Cl. CPC G06F 3/04847; G06F 3/04842; G06F 17/30867; G06F 17/30905

(57) ABSTRACT

Aspects extend to methods, systems, and computer program products for limiting visibility into user social media data based on user attributes. Aspects of the invention provide mechanisms for increasing data security for users of a social media site based on user attributes. A cloaking feature can be automatically activated and presented as active in a user-interface during account creation based on indicated user attributes (e.g., age). The cloaking feature increases both electronic and physical security for minors by preventing exposure to more adult interactions with other users. Adjustment of the cloaking feature allows users (e.g., minors or their parents) to control the audience with which they interact. For example, a 13-17 year old user can configure the cloaking feature so that other users ages 13-17 years old are able to interact with her or him but other users 18 years old or old are not.

### CROSS-REFERENCE TO RELATED APPLICATIONS

This application claims the benefit of and priority to U.S. Provisional Patent Application Ser. No. 62/064,312, entitled “Limiting Visibility Into User Social Media Data Based On User Attributes”, filed Oct. 15, 2014 by Nathaniel Brent Kranendonk et al., the entire contents of which are expressly incorporated by reference.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

For example, computer networks are frequently used for social networking. Multiple users can access social networking Web sites on the Internet to share information with one another, play games, access news, view deals, schedule meetings, etc. In some social networking environments, a large portion of user data (e.g., profile information, published content, etc.) is publicly visible. In other social networking environments, a user can use data access controls to control visibility of their user data.

Different social networking sites can have different default data visibility policies with respect to one user viewing another user's data. However, most, if not all, social networking sites handle account creation the same for all users and apply the same default policy to all user accounts. Default data visibility polices are typically applied upon user account creation. After account creation, a user can then change (e.g., increase or decrease) visibility into their user data as desired. Further, each user account is typically provided access to the same controls for changing visibility into their user data.

### BRIEF SUMMARY

The present invention extends to methods, systems, and computer program products for limiting visibility into user social media data based on user attributes. During online account creation for a social media system, a user can exchange network communication with the social media system to register with social media system through a user account creation process provided by a social media system. A user account (e.g., profile) creation process can automatically transition between different possible creation paths based on previously entered user attributes. For example, upon receiving an age attribute during account creation, user account creation can automatically transition to one account creation sub-path if a user's indicated age is 18 or older and another different account creation sub-path is a user's indicated age is younger than 18.

Each different account creation sub-path path can have a corresponding different user-interface that aggregates data from different locations for presentation to a user. Upon transitioning to a particular account creation sub-path, the social media system can construct a user-interface for the particular account creation sub-path. The social media system can transmit the constructed user-interface to a user computer system. The user computer system can display the user-interface at a display device to indicate the particular user creation path to a user. The user can enter account data into the user-interface and transmit the account data to the social media system.

In one account creation sub-path, the social media system automatically constructs a user-interface for a configuring cloaking feature when user data entered earlier in an account creation process indicates that a user is younger than 18 years old. The user-interface can indicate that, by default, that a cloaking feature is active. The cloaking feature restricts other users 18 years old or older from interacting with (viewing data of, sharing data with, or contacting) the user that is younger than 18 years old through the social media system.

In one aspect, a user can enter data through a cloaking feature user-interface to configure an age range of users permitted to access their user data. For example, a user (e.g., under 18 years old) can interact with a cloaking feature user-interface to select options that permit other users in an age range of 13-17 years old to access their user data but block other users 18 years old or older from access. A cloaking feature user-interface can include options for extending an age range of permitted users to other users that are 18 or older. For example, a user (e.g., under 18 years old) can interact with a cloaking feature user-interface to select options that permit other users in an age range of 13-21 to access their user data but block other users 22 or older from access.

Once established, an active cloaking feature can be used by a social media system to limit visibility into data of a social media system user. The social media system can receive a search request from a user through network communication. The search request includes a search term requesting profile data managed by the social media system. In response to the network communication, the social media system can initiate further network communication with a profile database to find a profile for another user that matches the search term. The social media system can identify an active cloaking attribute in the profile. The social media system determines that the profile is not to be returned in a response to the search request based on the cloaking attribute in view of the age of the user.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIGS. 1A and 1B illustrates an example computer architecture that facilitates limiting visibility into user social media data based on user attributes.

FIG. 2 illustrates a flow chart of an example method for limiting visibility into user social media data based on user attributes.

FIG. 3 illustrates a flow chart of an example method for limiting visibility into user social media data based on user attributes.

### DETAILED DESCRIPTION

The present invention extends to methods, systems, and computer program products for limiting visibility into user social media data based on user attributes. During online account creation for a social media system, a user can exchange network communication with the social media system to register with social media system through a user account creation process provided by a social media system. A user account (e.g., profile) creation process can automatically transition between different possible creation paths based on previously entered user attributes. For example, upon receiving an age attribute during account creation, user account creation can automatically transition to one account creation sub-path if a user's indicated age is 18 or older and another different account creation sub-path is a user's indicated age is younger than 18.

Each different account creation sub-path path can have a corresponding different user-interface that aggregates data from different locations for presentation to a user. Upon transitioning to a particular account creation sub-path, the social media system can construct a user-interface for the particular account creation sub-path. The social media system can transmit the constructed user-interface to a user computer system. The user computer system can display the user-interface at a display device to indicate the particular user creation path to a user. The user can enter account data into the user-interface and transmit the account data to the social media system.

In one account creation sub-path, the social media system automatically constructs a user-interface for configuring a cloaking feature when user data entered earlier in an account creation process indicates that a user is younger than 18 years old. The user-interface can indicate that, by default, that a cloaking feature is active. The cloaking feature restricts other users 18 years old or older from interacting with (viewing data of, sharing data with, or contacting) the user that is younger than 18 years old through the social media system.

In one aspect, a user can enter data through a cloaking feature user-interface to configure an age range of users permitted to access their user data. For example, a user (e.g., under 18 years old) can interact with a cloaking feature user-interface to select options that permit other users in an age range of 13-17 years old to access their user data but block other users 18 years old or older from access. A cloaking feature user-interface can include options for extending an age range of permitted users to other users that are 18 or older. For example, a user (e.g., under 18 years old) can interact with a cloaking feature user-interface to select options that permit other users in an age range of 13-21 to access their user data but block other users 22 or older from access.

Once established, an active cloaking feature can be used by a social media system to limit visibility into data of a social media system user. The social media system can receive a search request from a user through network communication. The search request includes a search term requesting profile data managed by the social media system. In response to the network communication, the social media system can initiate further network communication with a profile database to find a profile for another user that matches the search term. The social media system can identify an active cloaking attribute in the profile. The social media system determines that the profile is not to be returned in a response to the search request based on the cloaking attribute in view of the age of the user.

Aspects of the present invention may comprise or utilize a special purpose or general-purpose computer including computer hardware, such as, for example, one or more processors and system memory, as discussed in greater detail below. Aspects within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, aspects of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, wearables, multi-processor systems, microprocessor-based or programmable consumer electronics, network PCs, minicomputers, mainframe computers, mobile telephones, watches PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

During online account creation for a social media system, different account creation paths can have corresponding different user-interfaces that aggregate data from different locations for presentation to a user. The social media system can aggregate user-interface components as well as user data from different storage locations (e.g., local, network based, cloud based, etc.) to construct a user-interface for an account creation path. Thus, upon transitioning to a particular user creation path, the social media system can construct a user-interface for the particular user creation path. The social media system can transmit the constructed user-interface to a user computer system. The user computer system can display the user-interface at a display device to indicate the particular user creation path to a user. The user can enter account data into the user-interface and transmit the account data to the social media system.

Aspects of the invention provide mechanisms for increasing data security for users of a social media site based on user attributes. For example, data for users younger than 18 can be cloaked from (i.e., not visible to) other users that are 18 or older. A cloaking feature can be automatically activated and presented as active in a user-interface during account creation based on indicated user attributes (e.g., age). A cloaking feature can also be activated after account creation. The cloaking feature increases both electronic and physical security for minors by preventing exposure to more adult interactions with other users.

Adjustment of the cloaking feature allows users (e.g., minors or their parents) to control the audience with which they interact. For example, a user can configure the cloaking feature so that other users ages 13-17 are able to interact with her or him User interface controls (e.g., sliders) can be used to select the upper and lower age bounds for interacting with a user, such as, for example, 12-15 years old, 14-16 years old, 15-21 years old, 13-24 years old, etc.

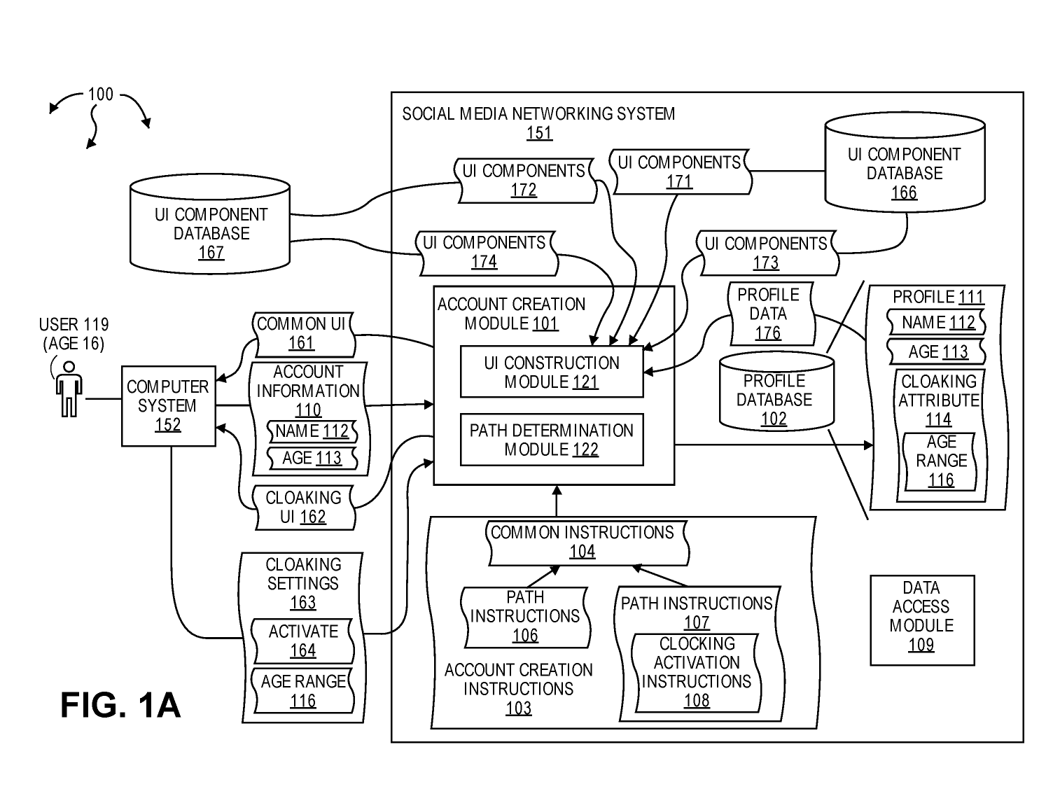

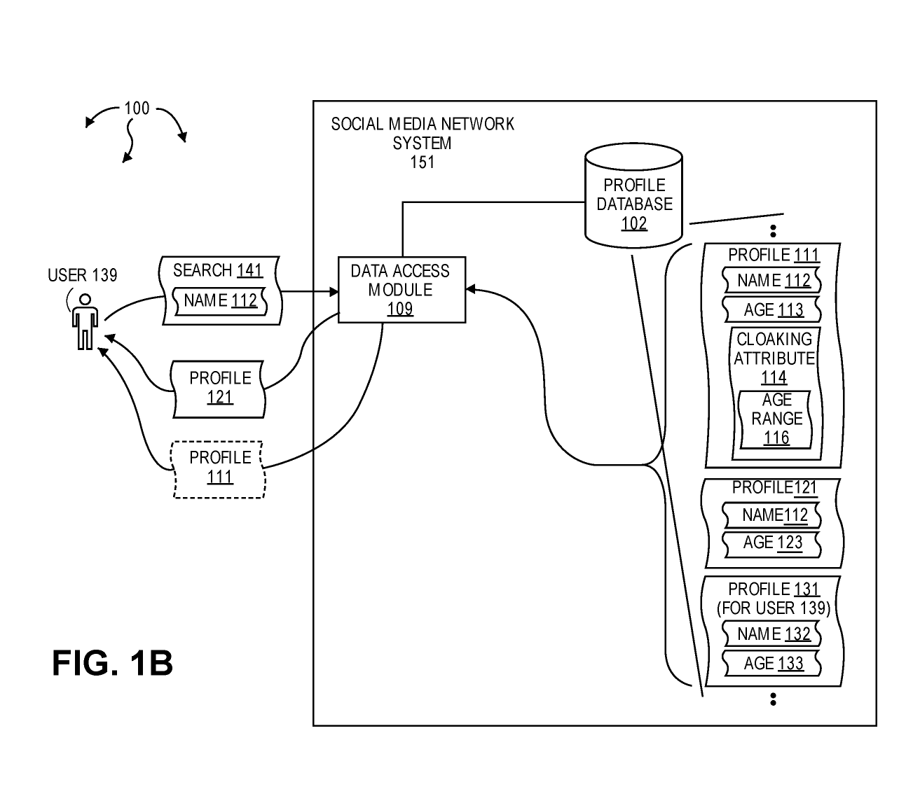

FIG. 1A illustrates an example computer architecture 100 that facilitates configuring limited visibility into user social media data based on user attributes. Referring to FIG. 1, computer architecture 100 includes data access module 109, social networking system 151, computer system 152, and User-Interface (UI) component database 167. Data access module 109, social networking system 151, computer system 152, and UI component database 167 can be connected to (or be part of) a network, such as, for example, a Local Area Network (“LAN”), a Wide Area Network (“WAN”), and even the Internet. Accordingly, data access module 109, networking system 151, computer system 152, and UI component database 167 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Social media networking system 151 further includes account creation module 101, profile database 102, and UI component database 166. In general, account creation module 101 is configured to create accounts for users of social media networking system 151. Profile database 102 is configured to store profile information for uses of social media networking system 151.

Social media networking system 151 can be a system where users exchange messages and/or other content with one another. Social media networking system 151 can include searching functionality to enable users to find information published by or otherwise associated with other users.

Account creation module 101 further includes UI construction module 121 and path determination module 122. Account creation module 101 can execute account creation instructions to take a user through an account creation path including a sequence of user-interface prompts for collecting account creation information. Account creation instructions can include conditional statements leading to different branches of instructions for account creation. Thus, account creation module 101 can follow various different account creation paths based on previously entered user attributes (e.g., age.). Accordingly, an account creation path is dynamic, switching between and/or combining different sub-paths later in the account creation process based on account information received earlier in the account creation process.

In general, path determination module 122 is configured to process account creation instructions and provides an account creation path to a prospective user of social media network system 151. Path determination module 122 can process conditional statements in account creation instructions to determine, for example, based on previously entered account information (e.g., age), when to transition between different account creation sub-paths. Different account creations sub-paths can be used to collect different data relevant to a particular user based on a context of previously entered account information. For example, if a registering user enters their age as 13 years old, data for configuring cloaking is relevant. As such, path determination module 122 can automatically transition to a cloaking configuration sub-path. On the other hand, if a registering user enters their age as 32 years old, data for configuring cloaking may not relevant. As such, path determination module 122 can continue with a current sub-path or transition to some other sub-path (other than a clocking configuration sub-path).

UI construction module 121 is configured to construct User-Interfaces (UIs) for account creation sub-paths. Each different account creation sub-path can potentially have a different UI. Each different UI can have different UI elements and different profile data that are relevant. For example, UI elements and profile data relevant to a UI for collecting demographic information can differ from UI elements and profile data relevant to a UI for configuring cloaking. A UI for one account creation sub-path can include profile data entered at another account creation sub-path. For example, an UI for demographic information can display a previously entered user name for a user. Likewise, a UI for configuring cloaking can display a previously entered age for a user.

Relevant UI components and profile data for a UI can be located in disparate locations, including locally within a system, on a LAN, on WAN, in a Cloud, etc. For example, UI component data 166 can be on a LAN accessible to social medial networking system 151. UI component database 167 can be located on the Internet. Profile database 102 can be located in a private cloud used by social networking system 151. UI construction module 121 can aggregate relevant data (e.g., UI elements and profile data) from disparate locations to construct a UI for an account creation sub-path. UI construction module 121 can aggregate different sets of relevant data (e.g., UI elements and profile data) on an on-going basis as path determination module 122 transitions between different account creation sub-paths.

In one aspect, UI component database 166 includes UI components developed and controlled by an owner (or manager) entity of social networking system 151 and UI component database 167 includes UI components from one or more independent 3rd party developers. As such, UI construction module 121 is able to integrate both internally managed UI components and 3^{rd} party managed UI components to construct a UI. Using UI components from 3^{rd} party developers allows UI construction module 121 to construct UIs from more recently developed UI components without associated ongoing development costs of developing the UI components. Using internally managed UI components allows UI construction module 121 to construct UIs having a stable look and feel associated with social media networking system 151. Integrating 3^{rd} party and internally managed UI components permits social media networking system 151 to utilize more recently developed UI techniques without disrupting the stable look at feel. Social media networking system 151 can compensate 3^{rd} party UI developers on a per UI component use basis.

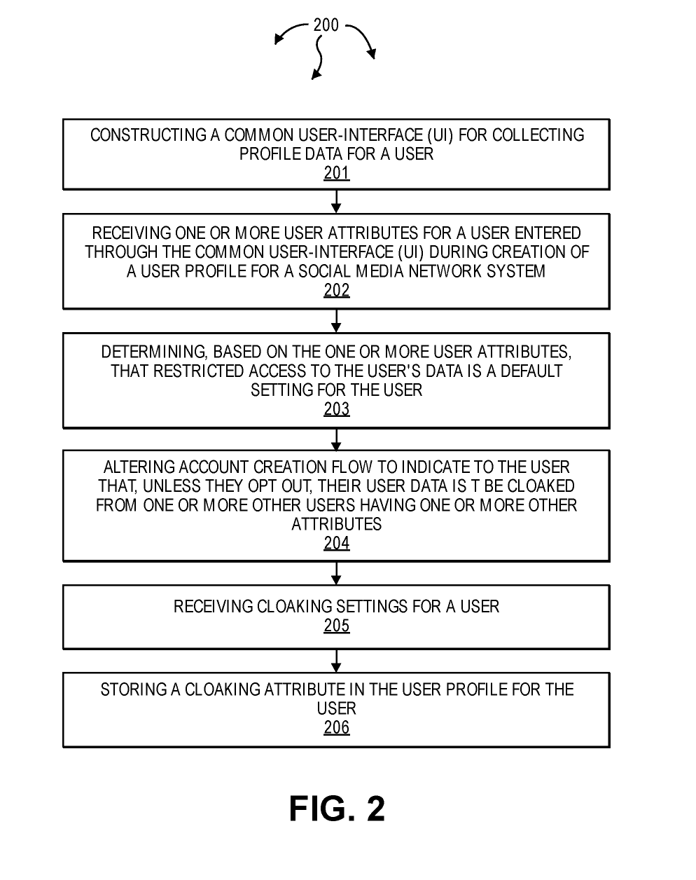

FIG. 2 illustrates a flow chart of an example method 200 for limiting visibility into user social media data based on user attributes. Method 200 will be described with respect to the components and data of computer architecture 100.

Method 200 includes an act of presenting a common user-interface (UI) (201). For example, account creation module 101 can access account creation instructions 103. To initiate an account creation process for user 119, account creation module 101 can execute common instructions 104. Common instructions 104 can instruct UI construction module 121 to construct a common UI for collecting profile attributes, including: demographic or other basic user attributes, such as, for example, name, age, city, state, etc.

Based on common instructions 104, UI construction module 121 can aggregate data from one or more of: UI component database 166, UI component database 167, and profile database 102 to construct common UI 161. For example, UI construction module 121 can aggregate UI components 171, UI components 172, and a previously entered user name into common UI 161. Social media networking system 151 can send common UI 161 to computer system 152. Computer system 152 can receive and present common UI 161 at a display device. Common UI 161 can include fields for collecting profile attributes, including: demographic or other basic user attributes, such as, for example, name, gender, interests, age, city, state, etc. In one aspect, common UI 161 includes a sequence of user-interface prompts for collecting account creation information.

Method 200 includes receiving one or more user attributes for a user (202). For example, user 119 can enter account information 110, including name 112 and age 113, into fields of common UI 161. Computer system 152 can return account information 110, including name 112 and age 113, to social media networking system 151. Account creation module can receive account information 110, including name 112 and age 113, from computer system 152. Account creation module 101 can write account information 110, including name 112 and age 113, to profile 111 (a profile for user 119).

In general, based on account information 110 and conditional statements in account creation instructions 103, path determination module 122 can determine that account creation is to transition (branch) to a different sub-path. Account creation module 101 can then execute path instructions for the different sub-path, such as, for example, path instructions 106 (one sub-path) or path instructions 107 (another sup-path) as appropriate.

More specifically, method 200 includes determining based on the one or more user attributes that restricted access to the user's data is a default setting for the user (203). For example, account creation module 101 can determine that access to user 119's data is, by default, to be restricted based on age 113 (i.e., 16 years old). Method 200 includes altering account creation flow to indicate to the user that, unless they opt out, their user data is to be cloaked from one or more other users having one or more other attributes (204). For example, path determination module 122 can transition account creation to path instructions 107 (a path for configuring a cloaking feature).

Account creation module 101 can execute path instructions 107. Path instructions 107 can instruct UI construction module 121 to construct a cloaking UI for configuring cloaking. Path instructions 107 include cloaking activation instruction 108 for configuring cloaking for user 119, including selecting an age range of users that are able to access user 119's data (e.g., profile data, published data, public messages, etc.). As such, the cloaking UI can be configured to receive an indication if cloaking is to be turned on or off and an age range of users that can still view user 119's data even when cloaked.

Based on path instructions 107, UI construction module 121 can aggregate data from one or more of: UI component database 166, UI component database 167, and profile database 102 to construct common UI 161. For example, UI construction module 121 can aggregate UI components 173, UI components 174, and profile data 176 (data from profile 111) to construct cloaking UI 162. Social media networking system 151 can send cloaking UI 162 to computer system 152. Computer system 152 can receive and present cloaking UI 162 at a display device. Cloaking UI 162 can include controls for collecting cloaking configuration data, such as, for example, a check box or button indicating if cloaking is to remain active or be deactivated and a slider bar indicating ages that can view user 119's data even when cloaked. Cloaking UI 162 can also display profile data 176 (i.e., previously entered profile data for user 119, such as, for example, name 112 and age 113).

Cloaking activation instruction 108 can instruct UI construction module 121 to create a UI including a sequence of user-interface prompts for configuring cloaking for user 119, including selecting an age range of users that are able to access user 119's data (e.g., profile data, published data, public messages, etc.). As such, in one aspect, cloaking UI 162 is a sequence of user-interface prompts for configuring cloaking for user 119.

In another aspect, UI 162 includes controls for indicating an age differential. Users within the age differential of age 113 can view user 119's data even when cloaked. For example, for a user aged 13-17 years old, other users less than four years older than the user may be able to access the user's data. Other users that are four years or more older than the user are prevented from accessing the user's data. Using a an age differential relieves a user from having to repeatedly update their cloaking attribute as she or he ages.

Method 200 includes receiving cloaking settings for a user (205). For example, user 119 can enter cloaking settings 163, including activate 164 and age range 116, into cloaking UI at computer system 152. Computer system 152 can return cloaking settings 163, including activate 164 and age range 116, to social media networking system 151. Account creation module 101 can receive account cloaking settings 163, including activate 164 and age range 116, from computer system 152.

In one aspect, instead of age range 116, cloaking settings 163 includes an age differential value.

Method 200 includes storing a cloaking attribute in the user profile for the user (206). For example, account creation module 101 can store cloaking attribute 114 in profile 111 to indicate that cloaking is active for user 119. Cloaking attribute 114 includes age range 116 (an age range of users that can still view user 119's data though it is cloaked). In general, account creation module 101 can include a cloaking attribute in a profile when cloaking is activated for a user.

In one aspect, instead of age range 116. Cloaking attribute 114 includes an age differential value.

Thus, when account creation is completed for user 119, account creation module 101 has populated profile 111 with profile data for user 119.

Turning to FIG. 1B, data access module 109 (e.g., a security module) controls access to user data. Data access module 109 can include a UI construction module (not shown) similar to UI construction module 121. The UI construction module can integrate UI components form different locations (e.g., UI component database 116 and UI component database 167) along with social media networking system data (e.g., profile data, message data, post data, etc.). The UI construction module can integrate more recently developed 3d party UI components with internally managed UI components that provide a stable look and feel to social media networking system 151.

As depicted, profile database 102 includes profile 111 (for user 119), profile 121, and profile 131 (for user 139). Profile 121 includes name 112 and age 123 for another user of social media networking system 151. Profile 131 includes name 132 and age 133 for user 139.

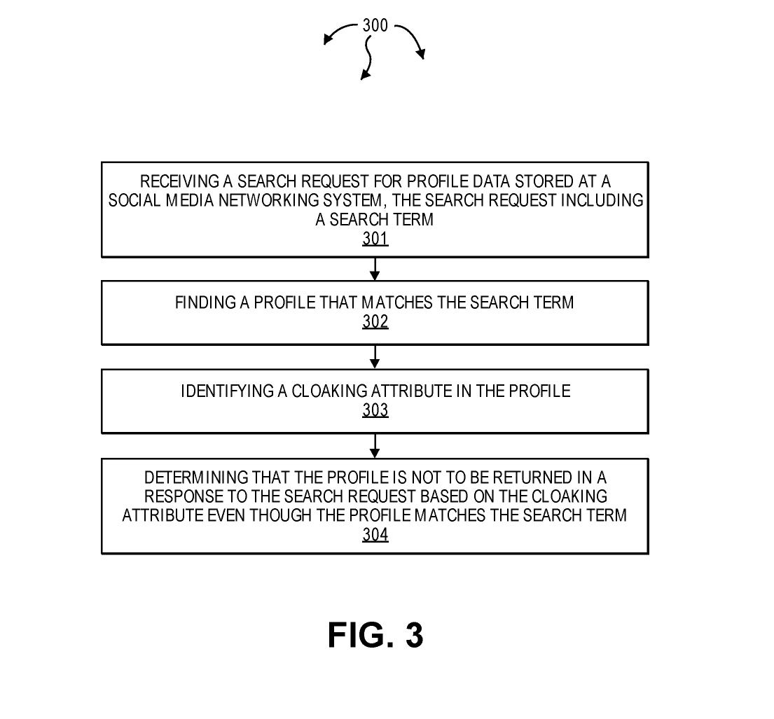

FIG. 3 illustrates a flow chart of an example method 300 for limiting visibility into user social media data based on user attributes. Method 300 will be described with respect to the components and data of computer architecture 100.

Method 300 includes receiving a search request for data stored at a social media networking system, the search request including a search term (301). For example, data access module 108 can receive search 141 from user 139. User 139 can submit search 141 to search for user profiles for users with name 112.

Method 300 includes finding a profile that matches the search term (302). For example, data access module 109 can access profiles in profile database 102 to attempt to locate users with name 112. Data access module 109 can find profiles 111 and 121 that match name 112.

Method 300 includes identifying a cloaking attribute in a profile (303). For example, data access module 109 can identify cloaking attribute 114 in profile 111. Method 300 includes determining that the profile is not to be returned in a response to the search request based on the cloaking attribute (304). For example, data access module 109 can determine that profile 111 is not to be returned in response to search 141 based on cloaking attribute 114 even though name 112 is a match.

For profiles that include a cloaking attribute, data access module 109 can perform a cloaking check, for example, checking user ages in different profiles against one another to determine if they are within a specified age range or age differential value. For example, profile 111 (for user 119) includes name 112 (a match for search 141), age 113, etc.

To perform a cloaking check, data access module 109 can determine if age 133 (the age of user 139) is within age range 116. If age 133 is not within age range 116, (e.g., age 133 indicates user 139 is 18 years old or older), profile 111 is not returned to user 139 in response to search 141. Alternately, data access module 109 can access age 113 and an age differential value. If age 133 is not within the sum of age 113 plus the age differential value, profile 111 is not returned to user 139 in response to search 141. Thus, even though name 112 matched search 141, user 139 is not provided information about user 119. As such, a cloaking check can override what would otherwise return a match.

On the other hand, if age 133 is within age range 116 (e.g., age 113 indicates user 139 is 14-17 years old), profile 111 can be returned to user 139 in response to search 141 (although other security checks may be applicable). Alternately, if age 133 is within the sum of age 113 plus the age differential value, profile 111 can be returned to user 139 in response to search 141.

For profiles that do not include a cloaking attribute, data access module 109 can return a matching profile to user 139 without a cloaking check (although other security checks may applicable). For example, profile 121 is for a user having name 112 (a match for search 114), age 123, etc. but does not include a cloaking attribute. As such, profile 121 can be returned to user 139 in response to search 141.

Method 300 was described with respect to profile data. Other similar methods can be used to limit visibility to a user's published data, public messages, etc. when processing a query.

In some aspects, account creation module operates in the following (or other similar sequence):
1. Enter Birthday and initial profile set-up:
   a. Outcomes:
      i. 18+->Proceed through Profile
      ii. <18->Follow new path below
2. The following user interface information can be presented for users under 18:
   “We take your safety seriously. Since you are under 18 years of age the system has turned on Cloaking (a feature that restricts adults 18 years or older—and not added as Friends—to view, contact or share with you. Cloaking does not restrict you from viewing, contacting and sharing with them). We recognize this may limit your experience but we recommend this additional safeguard. You can choose to disregard Cloaking by unchecking the box (check box displayed on screen).”
3. When box is checked: Turn on Cloaking [Checked box]
   a. Outcomes:
      i. User leaves box Checked and then clicks CONTINUE to proceed with profile set-up.
      ii. User Unchecks box (Continue with path below)
4. If the box is unchecked the following user interface information can be present to the user under 18: Be smart. Safety begins with you. You can still enable a Cloaking feature by setting a maximum age of people that can view, contact or share with you. Simply adjust the age ranges below (e.g., user interface sliders). (Age range starting with 13 and going to 100. Default values can set at 13 to 17)
   a. Outcomes:
      i. User sets age ranges and clicks CONTINUE
      ii. BACK button (taking them back to the prior screen, where the Cloaking feature is checked).

Thus, in general, social media networking system 151 can evaluate user safety in different ways. In addition to cloaking, block and report can also be used to help users under 18 years old control the audience with which they interact. Cloaking can be offered to all minors as they complete their profiles. When engaged, cloaking restricts the ability of adults 18 years or older—and not added as friends—to view, contact or share with them.

In some aspects, a social media network has a minimum age requirement, such as, for example, 13 years old, for registration. Prospective users under the minimum age requirement are not allowed to register.

Some minors are ready to present themselves to a more adult world (e.g., a 17 year old vs a 13 year old). In this aspect, another feature of cloaking sets the maximum age of people with whom to view, contact or share. This added flexibility can be offered only after the minor has opted out of more general cloaking.

In one aspect, when a user first enters a social media networking system, the user is asked basic profile question (age, gender, school, interests, etc.). In response, the social media networking system returns to the user a virtual stack of cards. The virtual stack of cards includes people, events, and promotions that the user can tap for more details. The user can then right or left swipe indicating they have interest or don't have interest in the card.

If two users independently swipe cards for each other indicating interest, the social media networking system can indicate the mutual interest each user. However, when one user has on cloaking, a cloaking check can be performed to see if users can be made aware of each other or not. An indication of mutual interest can be prevented if a user is cloaked, even if the user indicated interest in the other user.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

1. A method for use at computer system, the computer system including one or more processors and system memory, the method for configuring limited visibility into user social media data based on user attributes, the method comprising:
constructing a common user-interface (UI) for collecting profile data for a user;
receiving one or more user attributes for a user entered through the common user-interface (UI) during creation of a user profile for a social media network system;
determining, based on the one or more user attributes, that restricted access to the user's data is a default setting for the user;
altering account creation flow to indicate to the user that, unless they opt out, their user data is to be cloaked from one or more other users having one or more other attributes;
receiving cloaking settings for a user; and
storing a cloaking attribute in the user profile for the user.

2. The method of claim 1, wherein receiving one or more user attributes for a user during creation of a user profile comprises receiving an indication that the user is under 18 years old; and
wherein altering account creation flow to indicate to the user that, unless they opt out, their user data is to be cloaked comprises altering account creation flow to indicate to the user that, unless they opt out, their user data is to be cloaked from users that are 18 years old or older.

3. The method of claim 1, wherein altering account creation flow comprises:
constructing a cloaking user-interface (UI) for receiving cloaking settings from the user, the cloaking user-interface (UI) including a plurality of user-interface (UI) elements for receiving cloaking settings and at least one of the one or more user attributes for the user; and
sending the cloaking user-interface (UI) to a computer system of the user.

4. The method of claim 3, wherein constructing a cloaking user-interface (UI) comprises aggregating the plurality of user-interface (UI) elements from a plurality of user-interface (UI) element component databases along with profile data from a profile database.

5. The method of claim 1, wherein determining, based on the one or more user attributes that restricted access to the users data is a default setting for the user comprises determining based on an indicated age for the user that restricted access to the user's data is a default setting for the user.

6. The method of claim 5, wherein altering account creation flow to indicate to the user that, unless they opt out, their user data is to be cloaked from one or more other users comprises indicating to a user that their user data is to be cloaked from other users older than a specified age based on the indicated age for the user.

7. The method of claim 1, wherein constructing a common user-interface (UI) for collecting profile data for a user comprises integrating a plurality user-interface (UI) elements from a plurality of different user-interface (UI) element component databases to construct the common user-interface (UI).

8. A system, the system comprising:
a processor;
system memory; and
an account creation module, using the processor, configured to:
construct a common user-interface (UI) for collecting profile data for a user;
receive one or more user attributes for a user entered through the common user-interface (UI) during creation of a user profile for a social media network system;
determine, based on the one or more user attributes, that restricted access to the user's data is a default setting for the user;
alter an account creation flow to indicate to the user that, unless they opt out, their user data is to be cloaked from one or more other users having one or more other attributes;
receive cloaking settings for a user; and
store a cloaking attribute in the user profile for the user.

9. The system of claim 8, wherein an account creation module, using the processor, configured to receive one or more user attributes for a user during creation of a user profile comprises an account creation module, using the processor, configured to receive an indication that the user is under 18 years old; and
wherein an account creation module, using the processor, configured to alter account creation flow to indicate to the user that, unless they opt out, their user data is to be cloaked comprises an account creation module, using the processor, configured to alter account creation flow to indicate to the user that, unless they opt out, their user data is to be cloaked from users that are 18 years old or older.

10. The system of claim 8, wherein an account creation module, using the processor, configured to alter account creation flow comprises an account creation module, using the processor, configured to:
construct a cloaking user-interface (UI) for receiving cloaking settings from the user, the cloaking user-interface (UI) including a plurality of user-interface (UI) elements for receiving cloaking settings and at least one of the one or more user attributes for the user; and
send the cloaking user-interface (UI) to a computer system of the user.

11. The method of claim 10, wherein an account creation module, using the processor, configured to constructing a cloaking user-interface (UI) comprises an account creation module, using the processor, configured to aggregate the plurality of user-interface (UI) elements from a plurality of user-interface (UI) element component databases along with profile data from a profile database.

12. The method of claim 8, wherein an account creation module, using the processor, configured to determine, based on the one or more user attributes that restricted access to the users data is a default setting for the user comprises an account creation module, using the processor, configured to determine based on an indicated age for the user that restricted access to the user's data is a default setting for the user.

13. The method of claim 12, wherein an account creation module, using the processor, configured to alter account creation flow to indicate to the user that, unless they opt out, their user data is to be cloaked from one or more other users comprises an account creation module, using the processor, configured to indicate to a user that their user data is to be cloaked from other users older than a specified age based on the indicated age for the user.

14. The method of claim 8, wherein an account creation module, using the processor, configured to construct a common user-interface (UI) for collecting profile data for a user comprises an account creation module, using the processor, configured to integrate a plurality user-interface (UI) elements from a plurality of different user-interface (UI) element component databases to construct the common user-interface (UI).

15. A system, the system comprising:
a processor;
system memory; and
an data access module, using the processor, configured to:
receive a search request for profile data stored at a social media networking system, the search request including a search term;
find a profile that matches the search term in a profile database;
identify a cloaking attribute from within the profile; and
determine that the profile is not to be returned in a response to the search request based on the cloaking attribute even though the profile matches the search term.

16. The system of claim 15, wherein an data access module, using the processor, configured to determine that the profile is not to be returned in a response to the search request comprises an data access module, using the processor, configured to determine that the profile is not to be returned based on an indicated age of the user associated with the profile.

17. The system of claim 15, wherein an data access module, using the processor, configured to determine that the profile is not to be returned in a response to the search request comprises an data access module, using the processor, configured to determine that the profile is not to be returned based on an indicated age of a user that submitted the search request.

18. The system of claim 15, wherein an data access module, using the processor, configured to determine that the profile is not to be returned in a response to the search request comprises an data access module, using the processor, configured to determine that the profile is not to be returned based on an age differential between an indicated age of the user associated with the profile and an indicated age of a user that submitted the search request.
